(19) United States
(12) Patent Application Publication
(10) Pub. No.: US 2010/0263292 A1
(43) Pub. Date: Oct. 21, 2010

(54) MULTI-MATERIAL LAYERED EXTRUSION

(76) Inventor: Paul Harland, Middlebury, IN (US)

Correspondence Address: FAY SHARPE LLP, 1228 Euclid Avenue, 5th Floor, The Halle Building, Cleveland, OH, 44115, US

(21) Appl. No.: 12/528,043

(22) PCT Filed: Feb. 21, 2008
(86) PCT No.: PCT/US08/54535

§ 371 Date: Jul. 8, 2010

Related U.S. Application Data
(60) Provisional application No. 60/902,474, filed on Feb. 21, 2007.

(51) Int. Cl. E06B 7/16; B29C 47/00

(52) U.S. Cl. 49/475.1; 156/244.11

(57) ABSTRACT

A weatherseal is secured on a vehicle flange and includes an elastomeric body having a lip extending from one side thereof. The lip has a first layer that acts as a barrier layer and also secures a second or decorative layer thereto. The first layer has a sufficient thickness to serve as a color barrier. A core in the weatherseal can be broken and the second or decorative layer applied downstream of the first extrusion crosshead, and downstream of the rollers that achieve the breaking. The first and second layers are then applied in a second crosshead extrusion die.

### BACKGROUND OF THE INVENTION

This disclosure relates generally to a weatherstrip or weatherseal, and more particularly to a weatherseal for a door of an automotive vehicle. Typically, the weatherseal is secured to a flange surrounding a door opening to conceal or close the gap between the flange and body. Generally, a means for securing the weatherseal to the vehicle flange is provided which is often a generally U-shaped body portion defining a cavity received over the flange and having one or more gripping fingers extending inwardly into the internal cavity to grip the flange. The weatherseal may also include a core or reinforcing member, often a generally U-shaped core, that adds strength and rigidity to the securing means and is encapsulated in a rubber or EPDM material. A trim lip, or sealing lip, extends outwardly from one side of the exterior of the weatherseal. Additionally, a hollow seal member may extend outwardly from the other side of the exterior to form a seal with the door.

The trim lip portion of the weatherseal is typically disposed about the perimeter and ideally serves as a decorative, functional, or hiding lip. A top layer of a functional or decorative material such as a flock, flock tape, cloth tape, textured plastic tape, etc. is provided on the EPDM or rubber. Prior arrangements often encountered problems where the cloth become bunched or folded in corner areas where the weatherseal is mounted. For example, the core is often broken or separated even though the elongated weatherseal remains as a single piece in order to facilitate bending (cornering) and mounting of the weatherseal in corner regions. The decorative surface, such as cloth, can become damaged or marred.

Another problem encountered with these arrangements is that if the decorative layer is light colored, the black rubber or EPDM “bleeds through” or shows through the light colored decorative layer. Thus, attempts to color-coordinate the trim lip with the vehicle interior become more difficult based on the extent of the bleed through.

A need exists for an improved weatherseal that overcomes these problems, and others, as well as an associated improved method or process of manufacturing.

### SUMMARY OF THE INVENTION

A weatherseal includes an elongated elastomeric member having a core that aids in securing the elastomeric member to an associated vehicle flange. A lip extends outwardly from a portion of the elastomeric member and has one of a cloth or flock layer disposed thereon.

Preferably, a thermoplastic layer secures the cloth or flock layer on the lip.

The thermoplastic layer has a sufficient thickness to form a color barrier between the elastomeric member and the cloth or flock layer.

A seal bulb extends from the elastomeric member.

A method of forming the weatherseal provides an elastomeric body having a lip, forming a flange attachment mechanism on the body, applying a first layer of plastic on the lip, and securing either a flock or cloth decorative layer on the first layer.

The method includes extruding the elastomeric body, and incorporates a core in the body.

A further step in the process includes breaking the core at longitudinally spaced locations, and subsequently securing the flock or cloth decorative layer after the core breaking step.

The decorative layer is preferably secured to the first layer by extruding the first layer through an extrusion die.

A primary benefit of the disclosure relates to a multi-material extrusion that provides flexibility in the function of the top surface.

Either a color, flock, cloth, textured plastic, etc. may be used and the position on the extrusion line where the top layer is added may be altered.

The intermediate layer or middle layer serves as a suitable bond to the at least partially cured elastomeric layer to allow more options for the top layer.

Another benefit associated with this disclosure is the ability to color-coordinate the top layer with the interior of the vehicle.

Still another benefit resides in the improved appearance of the top layer.

Still other benefits and advantages of this disclosure will become apparent upon reading and understanding the following detailed description.

### BRIEF DESCRIPTION OF THE DRAWINGS

FIG. 1 is a partial side view of an automotive vehicle including a weatherseal of the type disclosed herein.

FIG. 2 is a cross-sectional view taken generally along the lines 2-2 of FIG. 1.

### DETAILED DESCRIPTION OF THE PREFERRED EMBODIMENT

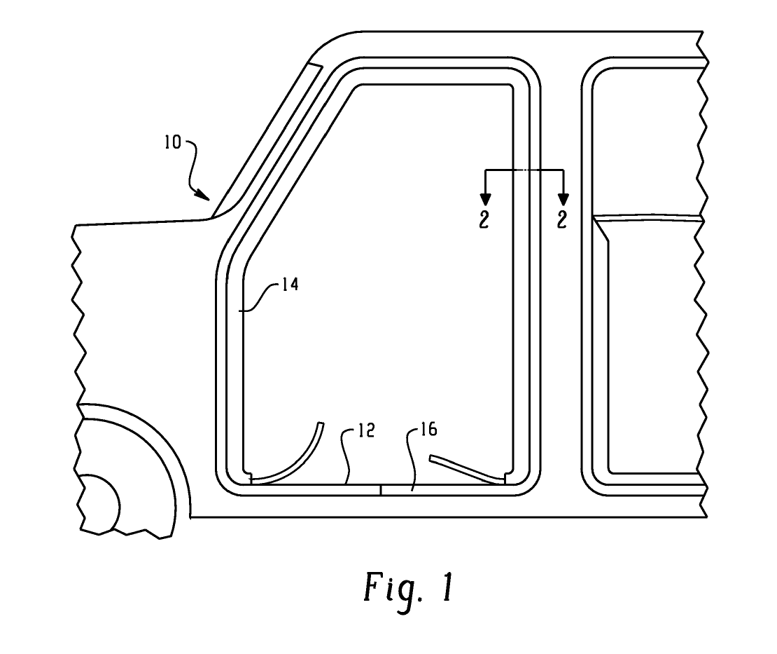

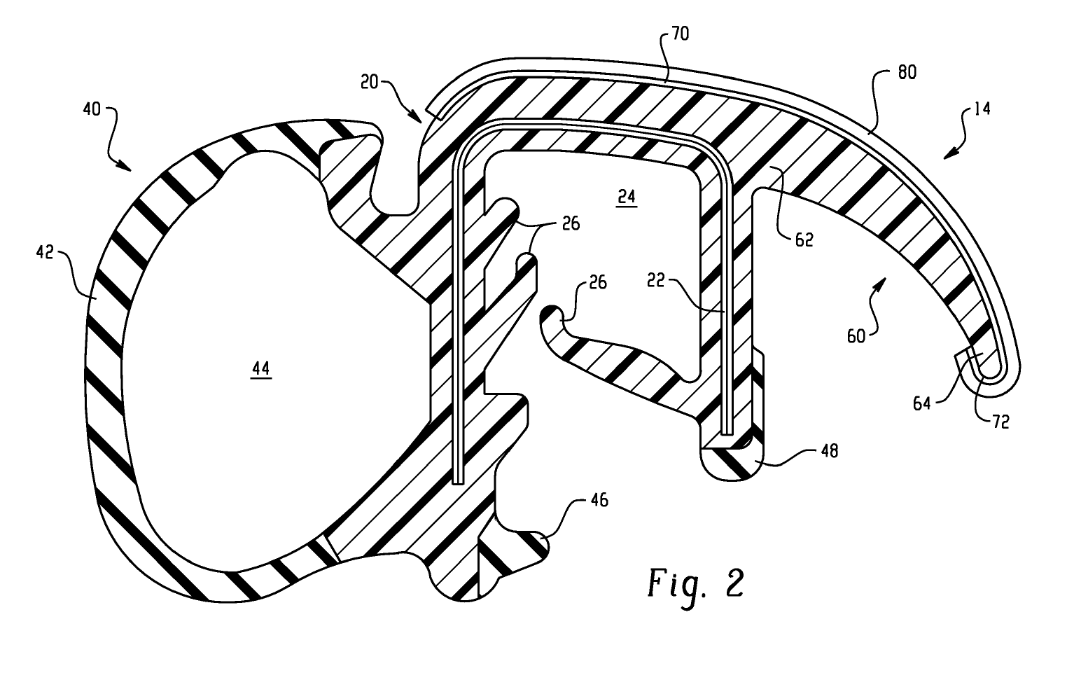

Turning to FIG. 1, an automotive vehicle 10 has a door opening 12 that receives a primary seal or weatherseal generally identified by reference numeral 14. The door has been removed for ease of illustration. A flange 16 is provided about the perimeter of the door opening and is typically a generally planar flange defined by the interconnection of first and second body panels that are welded or secured together as is well known in the art. The weatherseal includes an elastomeric member or body 20 (FIG. 2), a portion of which is typically reinforced with a reinforcing member or core, such as a generally U-shaped metal or plastic core 22. The elastomeric body encapsulates the core, and is typically co-extruded over the core. For example, a rubber or EPDM is commonly used as a co-extrusion over a metal core. In that region of the core, the elastomer has a similar profile, i.e., generally U-shaped to define a cavity 24 received over the vehicle flange 16. Extending inwardly into the cavity are one or more retaining members or fingers 26. In this manner, once the weatherseal is inserted over the vehicle flange, the retaining fingers prevent inadvertent removal.

Extending outwardly from one side of the elastomeric body 20 is a seal member, shown here as a hollow seal bulb 40. The seal may be formed in part by the body, such as the EPDM rubber, etc. and in part by a second material such as a compliant elastomeric material 42. Moreover, interior 44 of the seal may be hollow, partially filled. or filled with another material depending on the particular end use of the seal. Preferably, the body 20 and seal 40 are formed together, for example through a co-extrusion process, so that the dissimilar materials are fusion bonded together along their interface. Likewise, first and second regions 46, 48 are representative of other regions of the weatherstrip that may include a compliant elastomeric material that is either the same as the material 42 or of yet another material if so desired.

Extending along the base portion and outwardly from the other side of the elastomeric body is a lip 60. The lip can serve as a decorative, functional, or hiding lip that covers an underlying interface or surface of the vehicle. The lip extends outwardly from a thicker region 62 where it blends in with the remainder of the elastomeric body, to an outer terminal end 64 that is thinner and more flexible. Extending over the lip and also a base region of the body is a first layer 70, also referred to as an interconnect layer or barrier layer. Preferably, the first layer 70 is a thermoplastic vulcanizate (TPV) or other desired plastic that is co-extruded over the elastomeric material. As noted above, the first layer extends over a base region of the body and along an outer surface of the lip 60, and also extends over and beneath to an underside surface 72. It will be appreciated that the first layer of plastic such a TPE, TPV, TPO, etc., may be of a thickness ranging from, for example, 0.2 mm to 4.0 mm thick with a density of 0.6 to 1.3. It is preferably co- extruded on the underlying dense or sponge layer of the elastomeric body which would typically have a thickness ranging, for example, from 1.0 mm to 15 mm thick and a density of 0.6 to 1.3.

The first layer serves to bond a second or outer, decorative layer 80 to the elastomeric body. The second layer 80 may be a flock, flock tape, cloth tape, textured plastic tape, or cloth, etc. Preferably, the color of the flock, cloth, or textured plastic is such that it color-coordinates with the associated vehicle interior. Moreover, the first layer 70 is of a sufficient thickness to act as a color barrier. That is, if the second layer is of a light color, the black EPDM or rubber body will bleed through or adversely impact the color appearance of the second layer. Thus, it is desirable that the first layer 70 be of such a thickness that the impact of the black body not adversely impact on the final color of the outer layer 80. Thus, the first layer serves as both a bonding, or securing layer as well as a color barrier layer,

The use of the multi-layer construction 70, 80 is also advantageous from a production standpoint. For example, if the second layer 80 is a cloth, it is difficult to send a cloth through equipment where, for example, the core is broken at selected spaced regions in order to facilitate mounting of the weatherseal to the vehicle. The equipment that breaks the encapsulated core, but otherwise retains the structural integrity of the weatherseal along its longitudinal length, can adversely tear the cloth, for example. The core is broken at these regions in order to more easily mount the weatherseal to the vehicle, particularly to allow the elongated weatherstrip to bend at corner regions and sharp turns. The multi-layer arrangement, on the other hand, allows the underlying elastomeric body to at least partially cure as it proceeds from the first extrusion die, the core can be broken, and then the first and second layers extruded through a second co-extrusion die at a downstream location. For example, roll forms are typically used to break the carrier but it is disadvantageous to have the cloth in place in front (i.e, downstream) of the first co-extruder since the cloth would be damaged when the carrier is broken.

It will also be appreciated that the disclosure can be used in instances where there is no core, or where the core need not be broken. In that instance, the first and second layer or multi-layer approach still provides flexibility in the final function or appearance of the second surface.

The invention has been described with reference to the preferred embodiment. Modifications and alterations will occur to others upon reading and understanding this specification. It is intended to include all such modifications and alterations in so far as they come within the scope of the appended claims or the equivalents thereof

1. A weatherstrip comprising:
an elongated elastomeric member having a core received therein for securing the elastomeric member to an associated vehicle flange;
a lip defined along a portion of the elastomeric member for receipt in an associated vehicle interior; and
one of a cloth and flock layer disposed on the lip.

2. The weatherstrip of claim 1 further comprising a thermoplastic layer securing the one layer on the lip.

3. The weatherstrip of claim 2 wherein the thermoplastic layer is of sufficient thickness to form a color barrier between the elastomeric member and the one layer.

4. The weatherstrip of claim 1 wherein the core includes longitudinally spaced breaks for permitting the weatherstrip to be more easily bent along the breaks.

5. The weatherstrip of claim 1 wherein the one layer color coordinates with the associated vehicle interior.

6. The weatherstrip of claim 1 further comprising a seal bulb extending from the elastomeric member.

7. The weatherstrip of claim 6 wherein the seal bulb is hollow.

8. The weatherstrip of claim 1 wherein the core is generally U-shaped, and the elastomeric member includes at least one retaining finger adjacent the core for gripping the associated vehicle flange.

9. The weatherstrip of claim 1 wherein a portion of the elastomeric member forms a flange attachment.

10. A method of forming a weatherstrip comprising:
providing an elastomeric body having a lip;
forming a flange attachment mechanism on the body;
applying a first layer of plastic on the lip; and
securing one of a flock and cloth decorative layer on the first layer.

11. The method of claim 10 wherein the elastomeric body providing step includes the step of extruding the body.

12. The method of claim 11 wherein the elastomeric body providing step includes incorporating a core in the body.

13. The method of claim 12 further comprising breaking the core at longitudinally spaced locations.

14. The method of claim 13 wherein the securing step is completed after the core breaking step.

15. The method of claim 14 wherein the applying step is completed after the core breaking step.

16. The method of claim 10 wherein the first layer is of sufficient thickness to form a barrier layer so that the elastomeric body cannot be seen through the decorative layer.

17. The method of claim 10 forming step includes applying the elastomeric body over a generally U-shaped core.

18. The method of claim 10 further comprising including a seal bulb on the body.

19. The method of claim 10 wherein the elastomeric body providing step includes incorporating a core in the body, breaking the core at longitudinally spaced locations, and then inserting the elastomeric body through an extrusion die to apply the first layer.

20. The method of claim 19 wherein the decorative layer securing step includes introducing the decorative layer on to the first layer at the extrusion die.
